(19) United States
(12) Patent Application Publication
(10) Pub. No.: US 2007/0059665 A1
(43) Pub. Date: Mar. 15, 2007

(54) Image data processing for dental implant professionals

(75) Inventors: Gary Orentlicher, White Plains, NY (US); Douglas Goldsmith, Rye, NY (US); Seth Berkman, Ossining, NY (US)

Correspondence Address: LAW OFFICE OF LEO ZUCKER, 25 BANK STREET, SUITE 212-K, PO BOX 1194, WHITE PLAINS, NY, 10602-1194, US

(73) Assignee: Facial Imaging, LLC

(21) Appl. No.: 11/517,678

(22) Filed: Sep. 8, 2006

Related U.S. Application Data
(60) Provisional application No. 60/715,551, filed on Sep. 9, 2005.

(51) Int. Cl. A61C 8/00; A61C 5/00

(52) U.S. Cl. 433/173; 433/215

(57) ABSTRACT

A procedure for obtaining patient image data for planning and/or placing dental implants in a patient. The patient is scanned at a radiology facility and corresponding image data is obtained, for example, in a DICOM format. The image data is forwarded to a processing center, preferably over a secure data link. At the processing center, the image data is converted to a form that is usable on a PC to be operated by a treating implant doctor, and the converted data is stored on a server at the center. The server can then be accessed by the doctor using his/her PC and a network connection (e.g., the Internet) between the PC and the processing center. The converted image data is downloaded and saved in the doctor's PC, so that the doctor can run a dental implant planning program based on the downloaded image data for a given patient.

### CROSS REFERENCE TO RELATED APPLICATION

This application claims priority under 35 U.S.C. § 119(e) of U.S. Provisional Patent Application No. 60/715,551 filed Sep. 9, 2005, entitled “CT Scan Data Processing System for Dental Implants”.

### BACKGROUND OF THE INVENTION

1. Field of the Invention

The present invention concerns image data processing, particularly the processing and distribution of patient image data over networks.

2. Discussion of the Known Art

Great advances and high success rates have been achieved in the practice of implant dentistry over the last 25 years. Precision and predictable placement of implants are no longer relegated to a dental surgeon's individual skill or “best guess.” For example, the introduction of Nobel Biocare Procera Planner, Simplant Planner, Simplant View, Implant Logic Virtual Implant Planner (VIP) and other personal computer software has enabled implant doctors, dentists, surgeons and other dental professionals (referred to collectively as “implant doctors”) to place implants precisely according to a patient's individual anatomy. Surgical guides and computerized virtual reality systems now allow an implant doctor to transfer an effective treatment plan to the patient at the time of surgery. For example, Nobel Biocare has unveiled a system designed to provide patients with “Teeth in an Hour.” A common procedure in dental implant technology is the imaging of the patient's jaws by computerized axial tomography (CT) scans, for purposes of 3-D implant placement and planning.

U.S. Patent Application Publication No. 2004/0078212 (Apr. 22, 2004) discloses a system for allocating prosthetic installation work between at least three parties who may be interconnected via the Internet. A dental situation and fixture applications are simulated on a computer screen by a first party (a treating dentist, surgeon, prosthetist, or the like). A first set of components in connection with the prosthetic installation are produced by a second party (a dental technician or laboratory) with the aid of the simulation. A second set of components are supplied by a third party who may be a producer and supplier of basic elements and structural parts. The prosthetic installation is then assembled and fitted by the first party (dentist) using the first and the second sets of components.

U.S. Patent Application Publication No. 2005/0108058 (May 19, 2005) relates to a method of managing dental digital images and records. A central server is in network communication with a number of dental locations (i.e., dentists' offices), a number of service providers remote from the dental locations, and at least one storage device. A number of digital images of a patient's teeth are acquired at one of the dental locations to generate a set of dental records. A requesting message is transmitted from the dental location to at least one of the service providers through the central server, wherein the requesting message includes a request for service and the dental records. A confirmation of transmittal of the requesting message is provided to the to the dental location, and the location is permitted to review the status of the requesting message. A responding message is transmitted from the service provider to the dental location through the central server, wherein the responding message indicates an acceptance or rejection of the requesting message. Finally, a confirmation of the transmittal of the responding message is provided to the service provider. See also, U.S. Patent Application Publication No. 2004/0146221 (Jul. 29, 2004); No. 2004/0165791 (Aug. 26, 2004); and No. 2005/0043970 (Feb. 24, 2005).

While not directed specifically to dental imaging, U.S. Patent Application Publication No. 2004/0030585 (Feb. 12, 2004) concerns a system that produces a diagnostic image based on signals received over a network from a remote imaging data collector which lacks a data/image processor unit. The image is constructed by a server within the system and the constructed image data may then be transmitted from the system via the network to other sites including a medical practitioner. According to the publication, the practitioner may then view and interpret the constructed image data using a conventional PC.

U.S. Patent Application Publication No. 2002/0143574 (Oct. 3, 2002) relates to a system for integration of mobile imaging units into an application service provider (ASP), for storage of data and information system support. Like the '585 publication, the '574 publication aims to minimize the degree of processing or computing power required of mobile imaging units in the system. See also, U.S. Patent Application Publication No. 2002/0038226 (Mar. 28, 2002); and No. 2004/0141661 (Jul. 22, 2004).

Notwithstanding the known art, there is currently a need for a system and procedure that enables an implant doctor to obtain and store high quality image data to facilitate implant placement and planning for a patient, without having to incur the cost to acquire, operate and maintain complex CT scanning equipment.

### SUMMARY OF THE INVENTION

The present invention is directed to a procedure that obtains high quality, convenient, and affordable CT imaging for implant doctors who have access to a wide area or global data network such as the Internet.

According to the invention, a method of obtaining patient image data for planning and/or placing dental implants includes scanning the patient at a radiology facility, and obtaining corresponding scan image data for the patient. The obtained image data is forwarded to a processing center over a data link between the radiology facility and the processing center. At the processing center, the image data is transformed into a form usable on a computer system or PC operated by an implant doctor, and the image data is stored on a server at the processing center.

The implant doctor accesses the server at the processing center using his/her PC and a network connection between the PC and the processing center. The doctor downloads the image data from the processing center server over the network connection, and runs an implant planning program on the PC according to the downloaded image data.

For a better understanding of the invention, reference is made to the following description taken in conjunction with the accompanying drawing and the appended claims.

### BRIEF DESCRIPTION OF THE DRAWING

In the drawing:

FIG. 1 is a schematic block diagram of a patient image data processing system for use by dental implant doctors, according to the invention;

FIG. 2 shows two examples of scatter reduction in images produced from raw CT scan data;

FIG. 3 illustrates a masking process applied to the images produced from the raw CT scan data;

FIG. 4 illustrates images created for virtual treatment planning; and

FIG. 5 is a flow chart depicting a specific example of the inventive system.

### DETAILED DESCRIPTION OF THE INVENTION

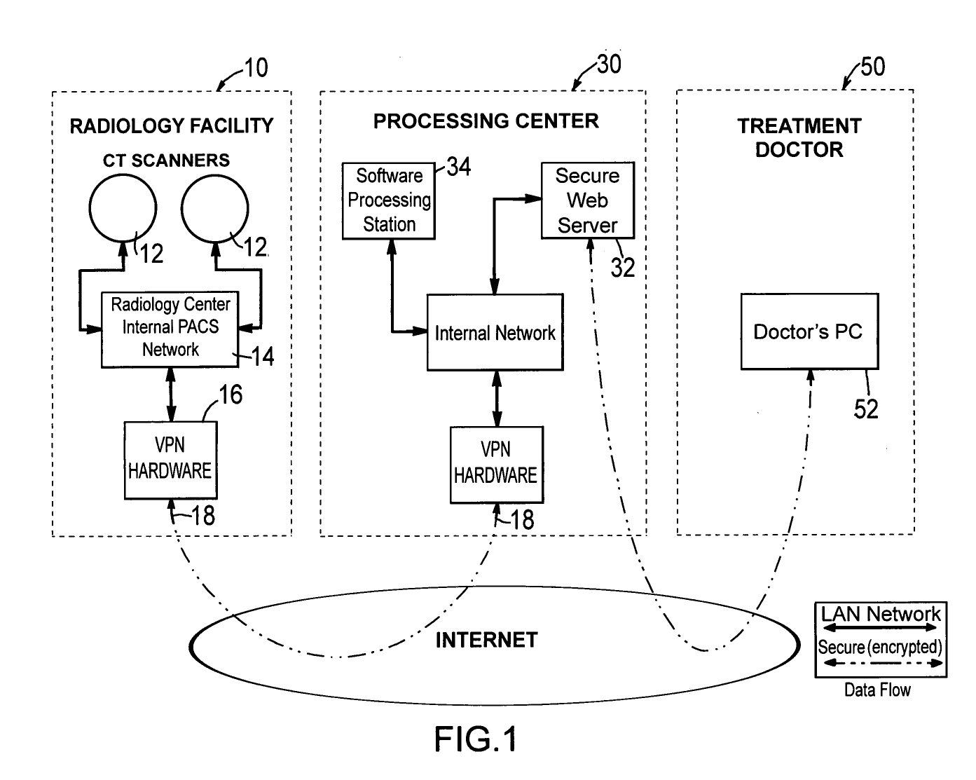

In FIG. 1, dental images are taken on an implant patient at a radiology facility 10 using one or more conventional CT scanners 12. The images may be stored in digital data form, for example, in a DICOM format. DICOM is a known standard medical image format in use for all CT and MRI type machines.

After the patient scan or scans are completed, the corresponding image data is forwarded through an internal network 14 to a central server 16 at the facility 10. The internal network 14 may be one known as a Patient Archive and Communication System (PACS) network, and the server 16 includes such hardware and software as to make the server 16 accessible from outside the facility 10 only via a secure data link 18, e.g., a virtual private network (VPN).

The DICOM image data is transmitted from the radiology facility 10 to a processing center 30 over the secure link 18. At the processing center 30, the two dimensional DICOM image data is interpolated and converted or transformed at a processing station 34 into data corresponding to three dimensional renderings using, e.g., Simplant Master software available from Materialise. After the data transformation at the station 34 is complete, a finished file is loaded into a folder in a secure web server 32 at the processing center 30, and each folder is associated with a specific outside doctor or facility 50. The web server 32 is preferably HIPAA compliant.

The doctor 50 may then download the information stored in his/her folder in the processing center server 32, onto a PC 52 at the doctor's office using commercially available software. The doctor 50 then can view patient images and construct a virtual treatment plan for a given patient. Nobel Biocare, Materialise, and Ident are examples of three companies currently known to offer proprietary software to doctors for virtual planning of dental implants in patients.

Specifically, as the implant doctor 50 retrieves the patient image data from the processing center 30, he/she may load the data into a folder created in his or her own personal computer 52 using the available software. The doctor 50 can then view the anatomy of the implant area, store the images, make specific anatomic measurements and, if desired, plan placement of dental implants virtually on the images. Once the treatment plan is complete, the doctor may send the completed plan to Nobel Biocare, Materialise, or other company whose software is being used by the doctor to fabricate a “surgical guide.” The surgical guide is used by the doctor to place the implants surgically and precisely at such locations, depths, and angulation as planned by the software in use.

For example, for doctors using Simplant software, the processed images may be supplied from the processing center server 32 in any one of a number of popular formats for viewing on the doctor's own particular PC 52. Doctors not currently using Simplant software may download the required software, e.g., “Simplant View” to enable the doctor to view the patient's CT scans, perform detailed measurements, and store the images in his/her computer system. For doctors using Nobel Biocare Procera Planner, the radiology center 10 may, for example, perform a “two CT scan” process to make the images available to the doctor in a format required for use with such software. For doctors lacking a computer system, the images may be provided on paper, films, or CDS.

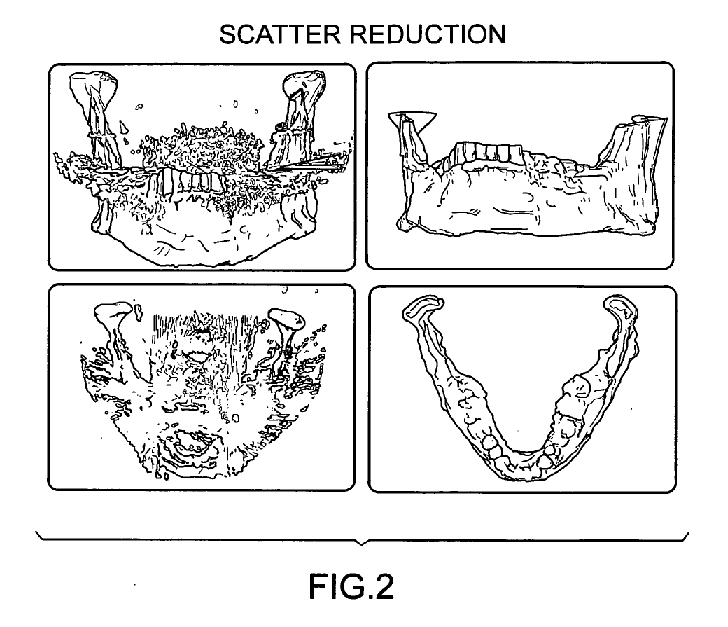

FIG. 2 shows two examples of scatter reduction in images produced from raw CT scan data. An editing module applied to the image data by the processing station 34 at the center 30 operates to remove scatter from metal restorations and thus provide high quality images.

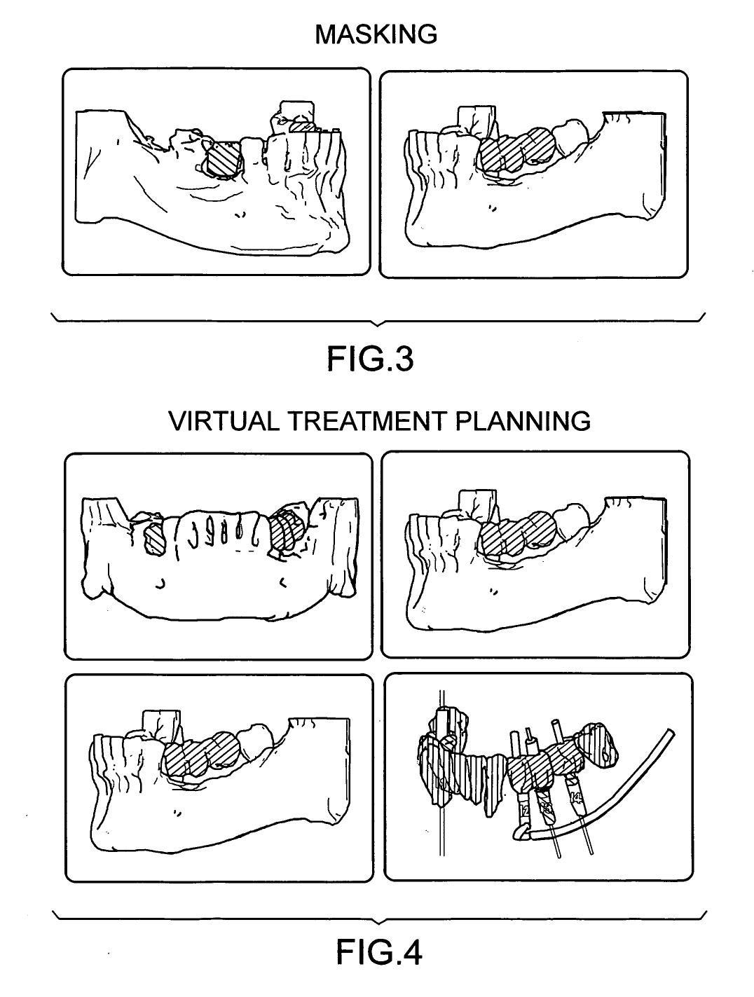

FIG. 3 illustrates a masking process applied by the station 34 at the center 30 to the images produced from the raw CT scan data. The process allows the implant doctor to visualize 3-D CT scan images with a specific structure being either present or absent.

FIG. 4 illustrates images created at the processing center 30 for use by the implant doctor 50 in connection with virtual treatment planning. Processing also allows the ability to remove bone and to visualize dentition, implants and vital structures.

### EXAMPLE 1

The inventive system and procedure is described further by the following example.

1. The treating implant doctor 50 evaluates the patient for dental implants, and orders a CT scan by writing the patient a special prescription form.

2. The patient calls a radiology facility 10 capable of carrying out the prescribed scan, and makes a CT scan appointment. One or more of the facilities 10 may be identified on the prescription form for the patient's selection.

3. The radiology facility 10 performs the CT scan, and the scan is preferably read by a qualified radiologist at the facility. The facility 10 sends a corresponding pathology report to the implant doctor 50.

4. The radiology facility 10 may collect a fee for its services, as well as for services to be performed at the processing center 30.

5. The radiology facility 10 sends the raw CT scan data (e.g., DICOM image data to the processing center 30 via the secure data link 18 using, e.g., 3DES-168 bit encryption.

6. The raw CT scan data is transformed by the processing station 34 at the center 30 using, e.g., Simplant Master software. If the implant doctor 50 is using non-Simplant software, the raw CT scan data may be processed and made available to the doctor in a different format.

7. The processing center 30 provides the data to the doctor in a useable format (CD, paper printouts, or films) as well as through a high speed Internet download via the web server 32 for planning treatment of the patient. The center 30 maintains and operates a secure, HIPAA compliant website on the Internet that the doctor can access using, e.g., an individual user name and password. The patient's CT studies may then be downloaded by the doctor directly into his/her computer system or PC 52 using the available software.

8. The processing center 30 may also process raw CT scan data for doctors who maintain their own imaging equipment, or for imaging centers that do not use Simplant software.

9. The processing center 30 interfaces with the implant doctor or group 50 that ordered the CT scan. The center 30 may also instruct the radiology facility 10 on how best to achieve a quality scan for various software packages currently in use.

### EXAMPLE 2

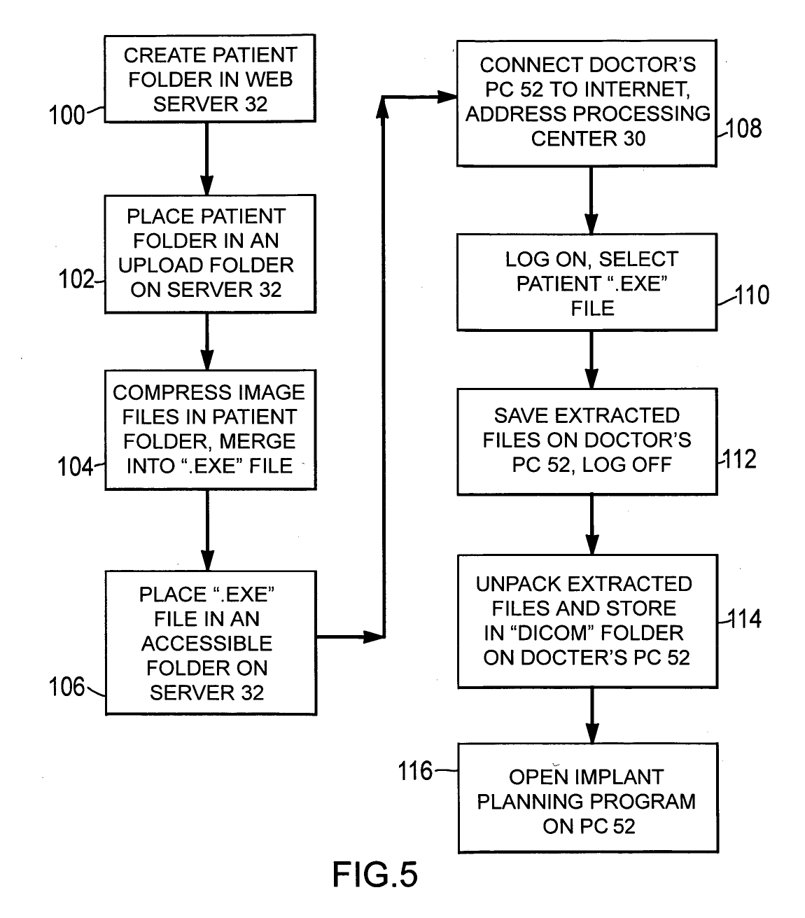

The following is a specific example of the invention for implant doctors and professionals using the currently available Nobel Biocare Procera Planner implant software. See FIG. 5.

In step 100, a patient folder is created in the web server 32 at the processing center 30 for containing the patient DICOM image files that were sent from the radiology facility 10 to the processing center via the secure link 18. The folder may be placed in, e.g., a “nobelupload” folder on the web server 32 (step 102). The folder may also be identified by the patient's name with a “_NB” tag at the end to alert an encoding program that the folder contains DICOM image files to be encoded.

In step 104 the DICOM image files are compressed, preferably to a size about one-half or less than that of the original image files, and the compressed files are merged into an executable file. The executable file is then placed in a folder that an implant doctor 50 can access via the Internet through the processing center's web site (step 106). The file includes a routine that will uncompress the image files when executed. The original folder that was placed in the “nobelupload” directory may then be removed from the processing center's web server 32.

In step 108, the implant doctor uses the PC 52 at his or her office to connect with the Internet, and to address the processing center's web site. The doctor logs in preferably by way of a username and password for security, and selects a patient file to be downloaded (step 110). The patient file name preferably has an “.exe” extension. In step 112, the extracted files are saved in, e.g., the common “Desktop” directory in the doctor's PC 52. The doctor may then log off the processing center's website.

Next, in step 114, the doctor 50 opens and runs the extracted files. The files uncompress and store themselves in a “DICOM” folder under a subfolder having the patient's name. This “DICOM” folder is automatically created on the hard drive of the doctor's PC 52 upon installation of the Nobel Biocare Procera Planner software. Once all the DICOM files are unpacked and stored in the “DICOM” folder, the files that were initially downloaded from the processing center 30 and saved in the doctor's “Desktop” directory, may be deleted.

In step 116, the implant doctor 50 opens the planning software on his/her PC 52, and starts a dental implant planning process based on the files stored in the “DICOM” folder under the patient's subfolder.

Accordingly, implant doctors having broadband Internet access may download studies from the secure server 32 at the processing center the same day or shortly after the patient is scanned at the radiology facility. Moreover, all of the CT image data handled at the processing center 30 may initially be reviewed by consultants at the center to ensure high quality of service.

While the foregoing represents preferred embodiments of the invention, it will be understood by those skilled in the art that various modifications and changes may be made without departing from the spirit and scope of the invention, and that the invention includes all such modifications and changes as come within the scope of the following claims.

We claim:

1. A method of obtaining patient image data for planning and/or placing dental implants in a patient, comprising:
scanning the patient at a radiology facility, and obtaining corresponding scan image data for the patient;
forwarding the obtained scan image data to a processing center over a data link between the radiology facility and the processing center;
transforming the forwarded scan image data at the processing center into a form usable on a computer system to be operated by an implant doctor, and storing the transformed image data on a server at the processing center;
accessing the server using a computer system or PC operated by the implant doctor and a network connection between the PC and the processing center;
downloading the transformed image data from the server at the processing center over the network connection and saving the data in the PC; and
running an implant planning program on the PC according to the saved image data.

2. The method of claim 1, including forwarding the scan image data from the radiology facility to the processing center in a DICOM format.

3. The method of claim 1, including securing the data link between the radiology facility and the processing center.

4. The method of claim 1, including securing the network connection between the doctor's PC and the processing center.

5. The method of claim 1, including compressing the transformed image data at the processing center before storing the data on the server for access by the implant doctor.

6. The method of claim 1, including fabricating a surgical guide for the patient after running the implant planning program on the doctor's PC.
